(19) United States
(12) Patent Application Publication
(10) Pub. No.: US 2003/0151277 A1
(43) Pub. Date: Aug. 14, 2003

(54) Structure multifunction computer chair support apparatus

(76) Inventor: Hong-Jen Chen, Shi Chou Shiang (TW)

Correspondence Address: RABIN & BERDO, P.C., Suite 500, 1101 14th Street, N.W., Washington, DC, 20005, US

(21) Appl. No.: 10/067,835

(22) Filed: Feb. 8, 2002

(51) Int. Cl. B62J 1/00

(52) U.S. Cl. 297/195.11

(57) ABSTRACT

A multifunction computer chair support apparatus consisting of foldable chair legs, an elbow cushion situated at the upper extent, a knee cushion disposed medially on one side, and an adjustment structure disposed at the lower extent of the elbow cushion and the knee cushion, wherein utilizing the said adjustment structure enables the free adjustment of the elbow cushion and the angle of the knee cushion. During computer operation, the elbows are straddled on the elbow cushion and the legs are postured against the knee cushion to increase the comfort of the user. The user can also lean on the elbow cushion to rest and, furthermore, utilize the computer chair for physical fitness exercising.

### BACKGROUND OF THE INVENTION

1) Field of the Invention

The invention herein relates to computer furniture, specifically an improved structure multifunction computer chair support apparatus.

2) Description of the Prior Art

As modern society becomes computerized, employment that requires being seated for extended periods has resulted in numerous fatigue-induced physical injuries. Modem business offices are equipped with chairs and desks, and office workers sit on chairs to operate desktop computers, wherein a mouse is manually utilized, the repetitive maneuvering of which leads to another type of work-related injury. As users operate computers, they lean directly against the hard desk when tired. If done for a prolonged length of time, hands ache from fatigue, with the continuous posturing of the head in the same position also resulting in similar discomfort from weariness. Due to equipment limitations, businesses only have office-use desk and chairs, with few having physical fitness equipment. As such, when personnel become tired after a period of work, they can only stand up and move about; there is no equipment for exercising and thereby shortening rest periods.

### SUMMARY OF THE INVENTION

The objective of the invention herein is to provide the said computer chair support apparatus which consists of foldable chair legs, an elbow cushion situated at the upper extent, a knee cushion disposed medially on one side, and an adjustment structure disposed at the lower extent of the elbow cushion and the knee cushion, wherein utilizing the said adjustment structure enables the free adjustment of the elbow cushion and the angle of the knee cushion; during computer operation, the elbows are straddled on the elbow cushion and the legs are postured against the knee cushion to increase the comfort of the user and, furthermore, the user can also lean on the elbow cushion to rest and, furthermore, utilize the computer chair for physical fitness exercising.

### BRIEF DESCRIPTION OF THE DRAWINGS

FIG. 1 is an exploded drawing of the invention herein.

FIG. 2 is an isometric drawing of the invention herein.

FIG. 3 is an orthographic drawing of an embodiment of the invention herein in the folded state.

FIG. 4 is an exploded drawing of another embodiment of the invention herein (1).

FIG. 5 is an isometric drawing of another embodiment of the invention herein (1).

FIG. 6 is an orthographic drawing of another embodiment of the invention herein, as viewed from a lateral perspective (1).

FIG. 7 is an orthographic drawing of another embodiment of the invention herein that illustrates its operation (1).

FIG. 8 is an exploded drawing of another embodiment of the invention herein (2).

FIG. 9 is an isometric drawing of another embodiment of the invention herein (2).

FIG. 10 is an orthographic drawing of another embodiment of the invention herein, as viewed from a lateral perspective (2).

### DETAILED DESCRIPTION OF THE INVENTION

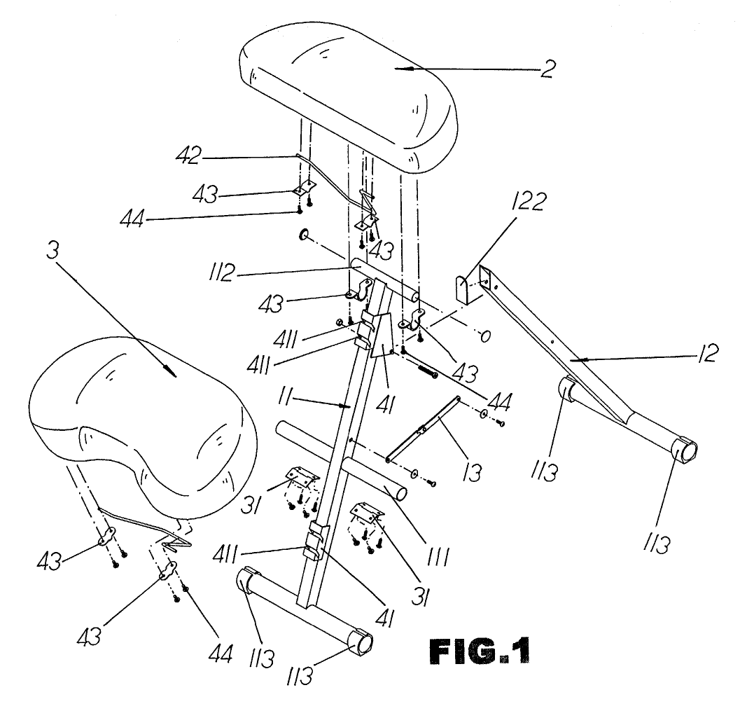

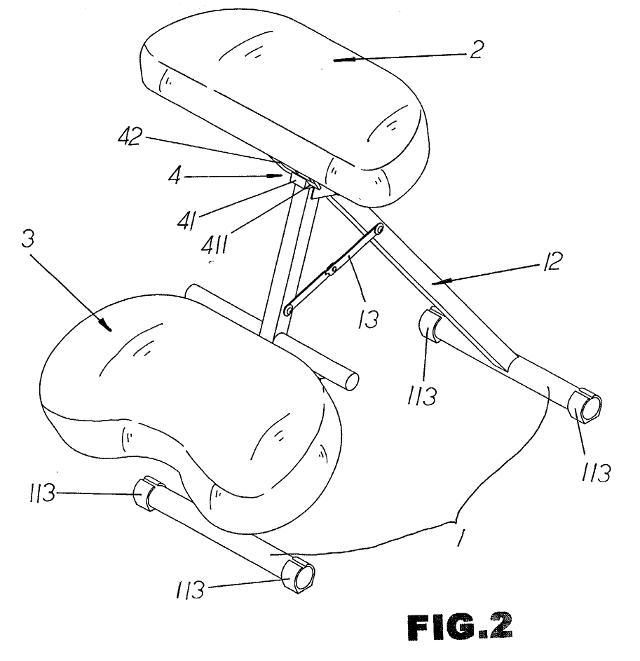

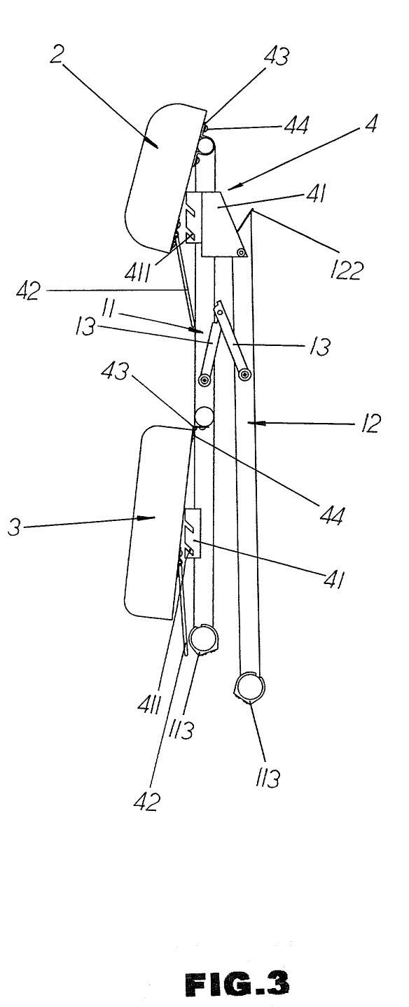

Referring to FIG. 1, FIG. 2, and FIG. 3, the exploded, isometric, and orthographic drawings of the invention herein.

The multifunction computer chair support apparatus is comprised of chair legs 1 consisting of a T-shaped anterior leg tube 11, a T-shaped posterior leg tube 12, and an I-shaped folding hinge 13 (utilized for folding and positioning) (as shown in FIG. 3); the said T-shaped posterior leg tube 12 is pivotably conjoined to the rear extent of the T-shaped anterior leg tube 11 in a inverted-V arrangement; the T-shaped anterior leg tube 11 has respectively situated at its medial and top sections a center horizontal tube 111 and an upper horizontal tube 112, with a leg cap 113 sleeved onto the bottom ends of each said T-shaped tube; a pad 122 is welded to the upper tubular opening of the said T-shaped posterior leg tube 12 and the I-shaped folding hinge 13 is installed between the T-shaped anterior leg tube 11 and the T-shaped posterior leg tube 12; an elbow cushion 2 is situated on the upper horizontal tube 112 of the T-shaped anterior leg tube 11, a knee cushion 3 is disposed onto one side of the T-shaped anterior leg tube 11, and a hinge 31 is fastened to the bottom portion of the knee cushion 3; the adjustment structure 4 consists of an adjustment base 41, an adjustment rod 42, a mounting element 43, and screws 44; the said adjustment base 41 is respectively positioned at a certain higher or lower height along the T-shaped anterior leg tube 11 and a plurality of adjustment holes 411 are formed in the adjustment base 41; the said adjustment rod 42 is U-shaped and respectively screw fastens two mounting elements 43 to the lower extent of the elbow cushion 2 and the knee cushion 3, which thereby constitutes the structure of the computer chair support apparatus. When the user assembles the said computer chair support apparatus, the user determines the arrangement of the elbow cushion 2 and the knee cushion 3 as required; when the user operates a computer and is handling a mouse, the arms are supported on the elbow cushion 2 and the legs are postured against the knee cushion 3 to reduce hand fatigue that occurs over an extended period of time; when the user wants to take a break, the legs can be postured straight over the knee cushion 3 until an appropriate duration of rest has been enjoyed.

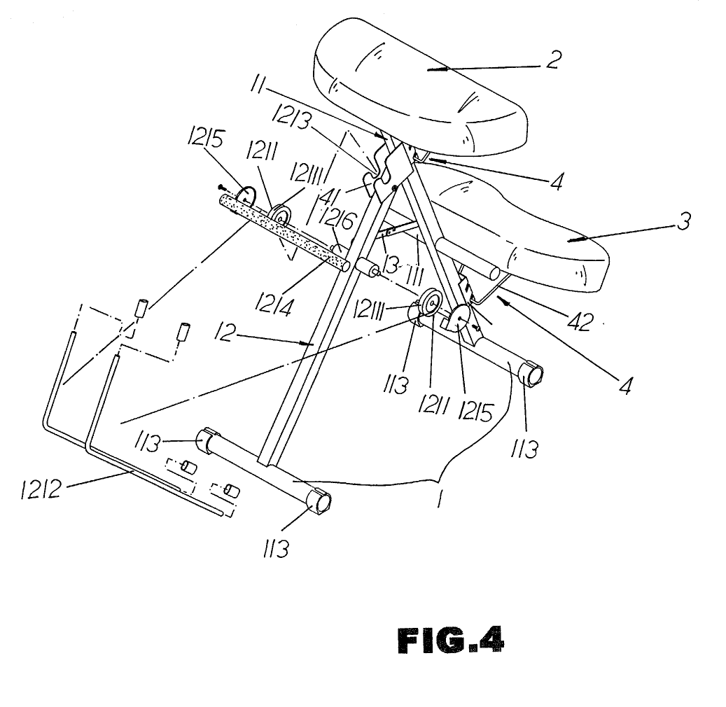

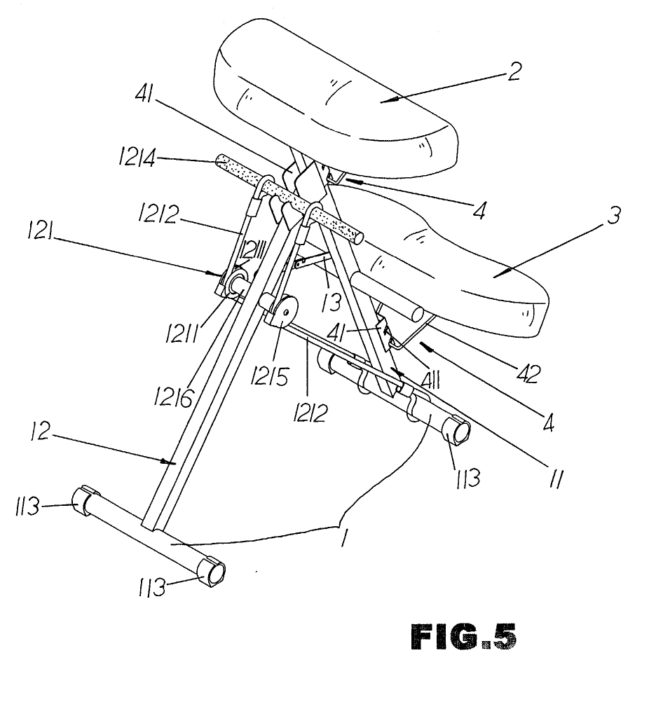

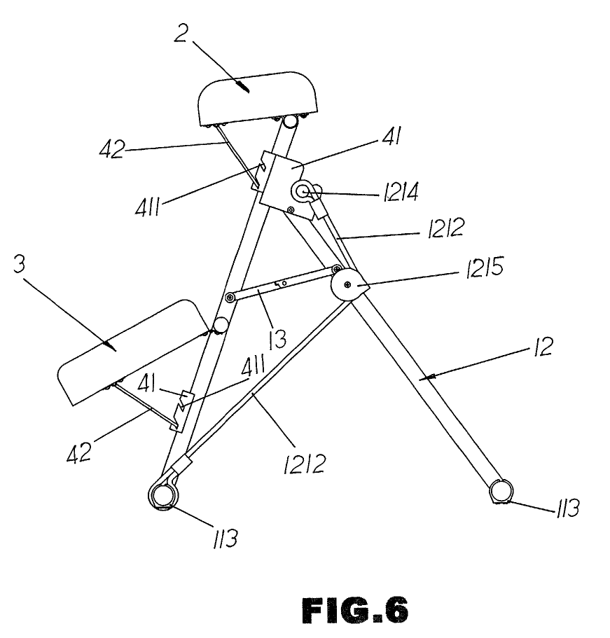

Referring to FIG. 4, FIG. 5, and FIG. 6, the drawings of another embodiment (1) of the invention herein, the said multifunction computer chair support apparatus is comprised of chair legs 1 consisting of a T-shaped anterior leg tube 11, a T-shaped posterior leg tube 12, and an I-shaped folding hinge 13 (utilized for folding and positioning) (as shown in FIG. 3); the said T-shaped posterior leg tube 12 is pivotably conjoined to the rear extent of the T-shaped anterior leg tube 11 in a inverted-V arrangement; the T-shaped anterior leg tube 11 has respectively situated at its medial and top sections a center horizontal tube 111 and an upper horizontal tube 112, with a leg cap 113 sleeved onto the bottom ends of each said T-shaped tube; a pad 122 is welded to the upper tubular opening of the said T-shaped posterior leg tube 12 and the I-shaped folding hinge 13 is installed between the T-shaped anterior leg tube 11 and the T-shaped posterior leg tube 12; the said elbow cushion 2 is situated on the upper horizontal tube 112 of the T-shaped anterior leg tube 11, the said knee cushion 3 is disposed onto one side of the T-shaped anterior leg tube 11, and a hinge 31 is fastened to the bottom portion of the knee cushion 3; the said adjustment structure 4 consists of an adjustment base 41, an adjustment rod 42, a mounting element 43, and screws 44; the said adjustment base 41 is respectively positioned at a certain higher or lower height along the T-shaped anterior leg tube 11 and a plurality of adjustment holes 411 are formed in the adjustment base 41; the said adjustment rod 42 is U-shaped and respectively screw fastens two mounting elements 43 to the lower extent of the elbow cushion 2 and the knee cushion 3, wherein there is a roller wheel structure 121 consisting of a roller wheel shaft 1216 extending a certain distance from each of the two sides of the T-shaped posterior leg tube 12 that are sleeved with a roller wheel 1211 and concealed by a roller wheel cover 1215, and a hole is formed in the said roller wheel cover 1215 (not shown in the drawings); one end of an elastic stay cord 1212 is fixed to the T-shaped posterior leg tube 12 and its other end is routed pass the grooves 12111 of the roller wheels 1211, following which the roller wheel covers 1215 are placed over such that they are conjoined to a handle bar 1214; the adjustment base 41 has a seating slot 1213 disposed across one side that provides for the positioning of the handle bar 1214; the design of the said adjustment base 41 is identical to that of the adjustment base 41 shown in FIG. 1, except for the addition of the seating slot 1213, which enables the user to pull the handle bar 1214 and utilize the tension of the stay cord 121 generated by the roller wheels 1211 to exercise the arms and thereby keep in shape.

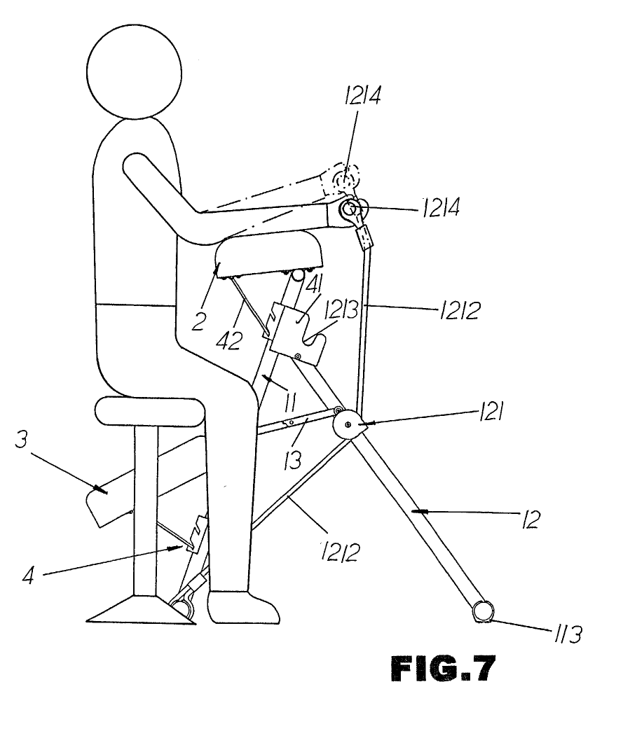

Referring to FIG. 7, the drawing of another embodiment (1) of the invention herein, when the user is utilizing the said computer chair support apparatus, the user can physically exercise by manually operating the roller wheel structure 121 to promote blood circulation, which is among the many functions of the computer chair of the present invention.

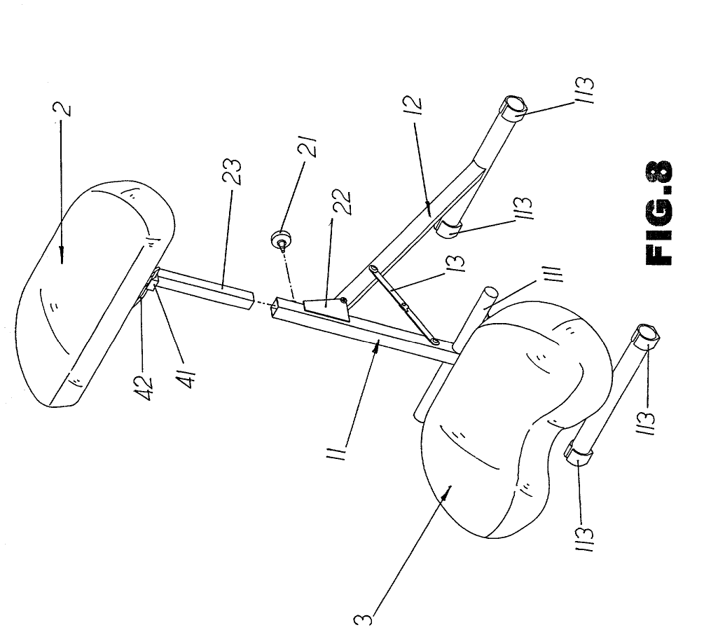

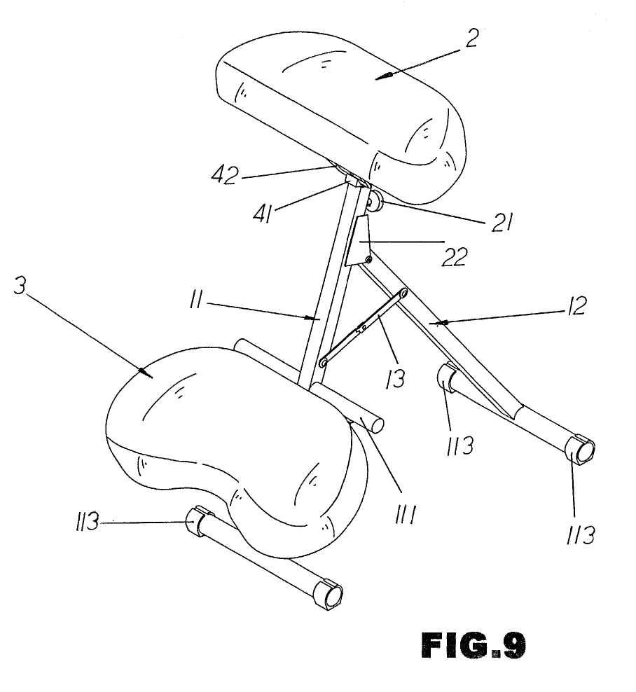

Referring to FIG. 8 and FIG. 9, the drawings of another embodiment (2) of the invention herein, the multifunction computer chair support apparatus is comprised of chair legs 1 consisting of a T-shaped anterior leg tube 11, a T-shaped posterior leg tube 12, and an I-shaped folding hinge 13 (utilized for folding and positioning) (as shown in FIG. 3); the said T-shaped posterior leg tube 12 is pivotably conjoined to the rear extent of the T-shaped anterior leg tube 11 in a inverted-V arrangement; the T-shaped anterior leg tube 11 has respectively situated at its medial and top sections a center horizontal tube 111 and an upper horizontal tube 112, with a leg cap 113 sleeved onto the bottom ends of each said T-shaped tube; a pad 122 is welded to the upper tubular opening of the said T-shaped posterior leg tube 12 and the I-shaped folding hinge 13 is installed between the T-shaped anterior leg tube 11 and the T-shaped posterior leg tube 12; the said elbow cushion 2 is situated on the upper horizontal tube 112 of the T-shaped anterior leg tube 11, the said knee cushion 3 is disposed onto one side of the T-shaped anterior leg tube 11, and a hinge 31 is fastened to the bottom portion of the knee cushion 3; the said adjustment structure 4 consists of an adjustment base 41, an adjustment rod 42, a mounting element 43, and screws 44; the said adjustment base 41 is respectively positioned at a certain higher or lower height along the T-shaped anterior leg tube 11 and a plurality of adjustment holes 411 are formed in the adjustment base 41; the said adjustment rod 42 is U-shaped and respectively screw fastens two mounting elements 43 to the lower extent of the elbow cushion 2 and the knee cushion 3, wherein an adjustment screw 21 is installed at one side of the upper tubular opening of the said T-shaped anterior leg tube 11, a pin mount 22 is situated at the conjoinment area of the T-shaped posterior leg tube 12, the elbow cushion 2 is attached to the tubular opening of the T-shaped anterior leg tube 11 by means of an elbow cushion stem 23, with the said elbow cushion stem 23 coupled into the tubular opening of the T-shaped anterior leg tube 11, and the adjustment structure 41 consisting of the adjustment base 41, adjustment rod 42, mounting elements 43, and screws 44 is disposed at the lower extent of the elbow cushion stem 23; a plurality of adjustment holes 411 are formed in the adjustment base 41, the said adjustment rod 42 respectively screw fastens the two mounting elements 43 to the lower extent of the elbow cushion such that the adjustment screw 21 is utilized to vary the elevation of the elbow cushion stem 23 according to the height of the user, with the said components thereby constituting the multifunction computer chair support apparatus.

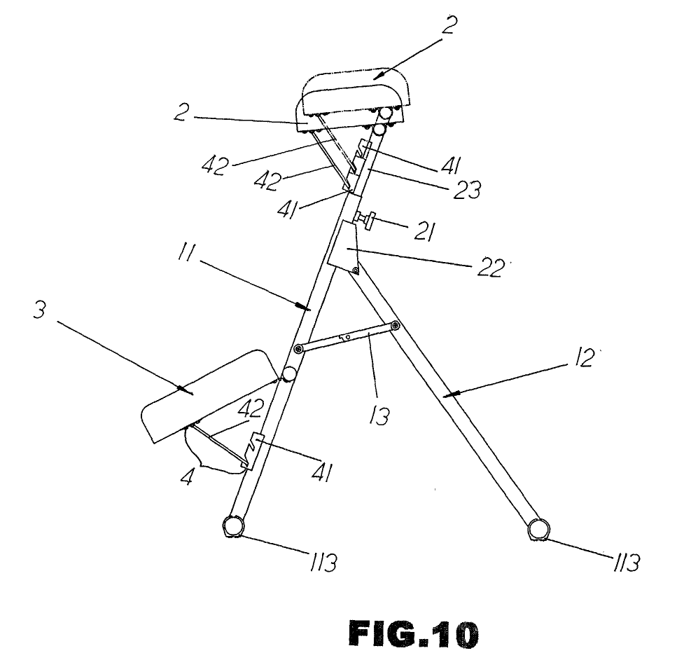

Referring to FIG. 10, the drawing of another embodiment (2) of the invention herein that illustrates its operation, when the user utilizes the computer chair support apparatus, the elevation of the elbow cushion stem 23 is changed utilizing the adjustment screw 21 to accommodate user height requirements, thereby facilitating the convenience of the computer chair support apparatus.

1. A multifunction computer chair support apparatus in which the support apparatus consists of foldable chair legs, an elbow cushion situated at the upper extent, a knee cushion disposed medially on one side, and an adjustment structure disposed at the lower extent of the said elbow cushion and the said knee cushion, wherein utilizing the said adjustment structure enables the free adjustment of the said elbow cushion and the angle of the said knee cushion.

2. As mentioned in claim 1 of the multifunction computer chair support apparatus of the invention herein, the said chair legs consist of a T-shaped anterior leg tube, a T-shaped posterior leg tube, and an I-shaped folding hinge; the said T-shaped posterior leg tube is pivotably conjoined to the rear extent of the said T-shaped anterior leg tube in a inverted-V arrangement; the said T-shaped anterior leg tube has respectively situated at its medial and top sections a center horizontal tube and an upper horizontal tube, with a leg cap sleeved onto the bottom ends of each said T-shaped tube; a pad is welded to the upper tubular opening of the said T-shaped posterior leg tube and the said I-shaped folding hinge is installed between the said T-shaped anterior leg tube and the said T-shaped posterior leg tube.

3. As mentioned in claim 1 of the multifunction computer chair support apparatus of the invention herein, the said adjustment structure consists of an adjustment base, an adjustment rod, a mounting element, and screws; the said adjustment base is respectively positioned at a certain higher or lower height along the said T-shaped anterior leg tube and a plurality of adjustment holes are formed in the said adjustment base; and the said adjustment rod respectively screw fastens two said mounting elements to the lower extent of the said elbow cushion and the said knee cushion.

4. A multifunction computer chair support apparatus comprised of the said chair legs consisting of the said T-shaped anterior leg tube, the said T-shaped posterior leg tube, and the said I-shaped folding hinge; the said T-shaped posterior leg tube is pivotably conjoined to the rear extent of the said T-shaped anterior leg tube in a inverted-V arrangement; the said T-shaped anterior leg tube has respectively situated at its medial and top sections a center horizontal tube and an upper horizontal tube, with the said leg cap sleeved onto the bottom ends of each said T-shaped tube; the said pad is welded to the upper tubular opening of the said T-shaped posterior leg tube and the said I-shaped folding hinge is installed between the said T-shaped anterior leg tube and the said T-shaped posterior leg tube; the said elbow cushion is situated on the said upper horizontal tube of the said T-shaped anterior leg tube, the said knee cushion is disposed onto one side of the said T-shaped anterior leg tube, and the said hinge is fastened to the bottom portion of the said knee cushion; the said adjustment structure consists of the said adjustment base, the said adjustment rod, the said mounting element, and the said screws; the said adjustment base is respectively positioned at a certain higher or lower height along the said T-shaped anterior leg tube and the said plurality of adjustment holes are formed in the said adjustment base; the said adjustment rod respectively screw fastens two said mounting elements to the lower extent of the said elbow cushion and the said knee cushion, wherein there is a roller wheel structure consisting of a roller wheel shaft extending a certain distance from each of the two sides of the said T-shaped posterior leg tube that are sleeved with a said roller wheel and concealed by a roller wheel cover, and a hole is formed in the said roller wheel cover; one end of an elastic stay cord is fixed to the said T-shaped posterior leg tube and its other end is routed pass the grooves of the said roller wheels, following which the said roller wheel covers are placed over such that they are conjoined to a handle bar; the said adjustment base has a seating slot disposed across one side that provides for the positioning of the said handle bar; and pulling the said handle bar draws the said stay cord such that tension generated by the said roller wheels provides for a physical fitness exercise.

5. A multifunction computer chair support apparatus is comprised the said chair legs consisting of the said T-shaped anterior leg tube, the said T-shaped posterior leg tube, and the said I-shaped folding hinge; the said T-shaped posterior leg tube is pivotably conjoined to the rear extent of the said T-shaped anterior leg tube in a inverted-V arrangement; the said T-shaped anterior leg tube has respectively situated at its medial and top sections the said center horizontal tube and the said upper horizontal tube, with the said leg cap sleeved onto the bottom ends of each said T-shaped tube; the said pad is welded to the upper tubular opening of the said T-shaped posterior leg tube and the said I-shaped folding hinge is installed between the said T-shaped anterior leg tube and the said T-shaped posterior leg tube; the said elbow cushion is situated on the said upper horizontal tube of the said T-shaped anterior leg tube, the said knee cushion is disposed onto one side of the said T-shaped anterior leg tube, and the said hinge is fastened to the bottom portion of the said knee cushion; the said adjustment structure consists of the said adjustment base, the said adjustment rod, the said mounting element, and the said screws; the said adjustment base is respectively positioned at a certain higher or lower height along the said T-shaped anterior leg tube and the plurality of said adjustment holes are formed in the said adjustment base; the said adjustment rod is U-shaped and respectively screw fastens two said mounting elements to the lower extent of the said elbow cushion and the said knee cushion, wherein an adjustment screw is installed at one side of the said upper tubular opening of the said T-shaped anterior leg tube, a pin mount is situated at the conjoinment area of the said T-shaped posterior leg tube, the said elbow cushion is attached to the tubular opening of the said T-shaped anterior leg tube by means of an elbow cushion stem, with the said elbow cushion stem coupled into the tubular opening of the said T-shaped anterior leg tube, and the said adjustment structure consisting of the said adjustment base, the said adjustment rod, the said mounting elements, and the said screws is disposed at the lower extent of the said elbow cushion stem; a plurality of said adjustment holes are formed in the said adjustment base, the said adjustment rod respectively screw fastens the two said mounting elements to the lower extent of the said elbow cushion such that the said adjustment screw is utilized to vary the elevation of the said elbow cushion stem according to the height of the user.
